(19) United States
(12) Patent Application Publication
(10) Pub. No.: US 2014/0279550 A1
(43) Pub. Date: Sep. 18, 2014

(54) Software Upgrades Using Tokens and Existing Licenses

(71) Applicant: MICROSOFT CORPORATION, Redmond, WA (US)

(72) Inventors: Ning Zhang, Bothell, WA (US); Mikael Horal, Sammamish, WA (US); Brian Perlman, Bothell, WA (US); Hakki Bostanci, Redmond, WA (US); Hariharan Jayaraman, Sammamish, WA (US); Rama Krishnan Venkatachalam, Redmond, WA (US)

(73) Assignee: MICROSOFT CORPORATION, Redmond, WA (US)

(21) Appl. No.: 13/802,933

(22) Filed: Mar. 14, 2013

(51) Int. Cl. G06Q 20/40

(52) U.S. Cl. CPC G06Q 20/401
USPC 705/59

(57) ABSTRACT

An upgrade to a computer program is associated with a token which is in turn associated with the original key for the computer program. In particular, given the original key, a publisher provides a token for the upgrade which is digitally signed and associated with the original key. The token also can result in a license state for the upgrade that is different from the license state for the original computer program. The original key can be used in various business rules by the publisher to determine whether to issue the token and/or what license state to associate with the token. When the upgrade is run on the computer, the verification process authenticates the token, the original license and the original key and authorizes execution of the upgrade based on the token for upgrade. Multiple upgrades can use multiple tokens and the original key.

### BACKGROUND

A common problem in computer systems is providing a mechanism for authenticating and authorizing the use of computer programs on the computer system. The two primary purposes of authentication and authorization are to enforce licensing restrictions placed on computer programs and to prevent installation or operation of malicious computer programs. Such authentication and authorization are typically performed when a computer program is initially installed on a computer, and when that computer program is updated or upgraded. Updates to a computer program typically are modifications that are provided free of charge and that are intended to fix errors, vulnerabilities or other usability issues but generally do not add new functionality. Upgrades to a computer program typically are modifications that add substantial new functionality. Additionally, authentication and authorization typically are performed when the computer program is executed by a computer.

Authentication herein is intended to mean any action that is taken to verify that the computer program is received from a trusted source. Authorization is intended to mean any action taken to ensure that the computer program is permitted to be executed on the computer on which the computer program is installed.

Authentication and authorization commonly are provided by using a key, i.e., information that acts as a proof of purchase and that a publisher can associate with a single copy of a computer program, in combination with data that identifies a computer on which that copy of the computer is to be installed and executed, herein called a hardware identifier. The key and the hardware identifier allow for authentication and authorization to occur upon installation and execution of that computer program on the computer.

When the computer program is first installed on a computer, the computer provides the key and the hardware identifier of the computer to the publisher. In turn, the publisher stores data, typically in a database, that associates the key with the computer. By checking if the key has already been associated with one or more other computers, the publisher can determine whether to authorize the installation of the computer program on this computer. The publisher also creates a digitally signed license indicating the pairing of the key and the hardware identifier, which is stored on the computer on which the computer program is installed. This license can also include a variety of information about the state of the license and other information related to the computer program. By changing the license, various restrictions on the use of the computer program can be effected, such as trial versions with limited functionality.

When the computer program is executed on the computer, a process checks the digitally signed license to verify the authenticity of the publisher and to determine whether, and to what extent, execution of the computer program is authorized.

Using such techniques, when a computer program is updated, the modified computer program typically is associated with the existing key, hardware identifier and license. When a computer program is upgraded, the modified computer program typically is associated with a new key and the existing hardware identifier. The license may remain the same or may be modified as well.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

With existing licensing mechanisms, some kinds of key usage can introduce key management problems. For example, some computer programs are installed on a computer by the computer manufacturer, and keys may be stored in permanent memory devices on the computer at the time of manufacture. If an upgrade to the computer program were to use a new key, that new key cannot easily be stored in the same location as the original program in such a permanent memory device as tools to do so are generally unavailable to end users.

Existing licensing mechanisms also limit the ability of a publisher to provide different pricing for license updates and upgrades based on the installation and use of prior versions of a computer program. For example, if a computer program is upgraded and a new key is used for the upgrade, then the key of the prior version, and information about the license, are not necessarily retained. In such a case, a publisher would not be able to provide pricing for an upgrade based on use of the prior version.

To address these and other issues, an upgrade to a computer program is associated with a token which is associated with the original key for the computer program. In particular, given the original key, a publisher provides a token for the upgrade which is digitally signed and associated with the original key. Use of the token allows an upgrade to be associated with an original key without modifying firmware if the original key is stored in a permanent memory device in the computer. The token is the license for the upgrade and can result in a different license state than the original computer program. The license based on the original key can be used in various business rules by the publisher to determine whether to issue the token and/or what license state to associate with the token. When the upgrade is run on the computer, the verification process uses the original key, the original license and the token for authentication, and authorizes execution of the upgrade based on the license for the upgrade. Multiple upgrades can use multiple tokens and the original key.

With such a structure, it is also possible for the upgrade for a computer program from a first publisher to be provided by a second publisher that is different from the first publisher. In such a case, a license verification process of the first computer program from the first publisher accesses chain of trust information during authentication of the token to verify that the second publisher is a trusted entity. Further, the “upgrade” for a first computer program, such as an operating system, can be a second computer program which is entirely different from the first computer program, such as an application that runs on the operating system.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### DESCRIPTION OF THE DRAWINGS

FIG. 1 is a block diagram of an example implementation of a computer system that enforces licenses of computer programs on computers.

FIG. 2 is a block diagram of an example computer.

FIG. 3 is a data flow diagram illustrating an example implementation of a publisher's licensing system for upgrading a computer program.

FIG. 4 is a data flow diagram illustrating an example implementation of a computer that authenticates and authorizes execution of an upgraded computer program.

FIG. 5 is a flow chart describing an example implementation of upgrading a computer program.

FIG. 6 a flow chart describing an example implementation of authenticating and authorizing execution of an upgraded computer program.

### DETAILED DESCRIPTION

Referring to FIG. 1, an example implementation of a computer system that enforces licenses of computer programs on computers will now be described. A computer 100 includes a computer program 102 that has an associated key 104 and license 106. The license 106 is digitally signed by a publisher to allow authentication. A license verification module 108 enforces the license when the computer program 102 is executed. In particular, the license verification module 108 authenticates the license 106, optionally using the key and hardware identifier, and then authorizes execution of the computer program based on the license 106. The license verification module can be a service in an operating system, part of computer program 102 and/or part of an upgrade 170.

A publisher typically distributes copies of a computer program 102, each copy having a key 104 that is unique to that copy. The license state of the computer program is initially inactive when first distributed so that the computer program cannot be executed by a computer. The license state is changed to active after the computer program is loaded onto a computer and a process is initiated by the user to obtain a license to the computer program.

In general, the computer 100 connects to a publisher's licensing system 150, typically over a computer network (not shown), in order to obtain a license to the computer program. After obtaining a license, verification of that license upon execution changes the license state so as to authorize execution of the computer program. To obtain a license to the computer program, the computer 100 provides to the publisher's licensing system 150, the key 104 and a hardware identifier 110, which is any information requested by the publisher that is intended to uniquely identify the computer. Given the hardware identifier 110 and the key 104 for the computer program, the publisher's licensing system 150 provides digitally signed license 106 which the verification module uses to enforce the terms of the license to the computer program.

If an upgrade 170 to the computer program 102 is distributed, the upgrade can be distributed without any new key. Its license state is initially inactive. When the upgrade 170 is installed on the computer 100, a license can be obtained. In particular, the computer 100 sends the current product key 104 to the publisher's licensing system 150. The original license 106 and hardware identifier 110 also can be provided, but are optional. The publisher's licensing system verifies that the key is valid, and then generates a license for the upgrade according to business rules established by the publisher. As an example, if the original computer program is in a trial mode with reduced features, then the upgrade can remain in that same trial mode with reduced features. The licensing system 150 provides a digitally signed token 172 as the license for the upgrade, which may result in a license state for the upgrade which is the same as or different from the license state for the original program.

After the computer receives the token, the upgraded computer program can be executed according to the license provided by the token. In particular, authentication is based on the original key, the original license and the token, and execution of the upgraded computer program is authorized according to the license state resulting from authenticating the token, in a manner to be described in more detail below.

A computer on which the computer program and the licensing system are designed to operate will now be described. The following description is intended to provide a brief, general description of a suitable computer with which such a system can be implemented. The computer can be any of a variety of general purpose or special purpose computing hardware configurations. Examples of well-known computers that may be suitable include, but are not limited to, personal computers, server computers, hand-held or laptop devices (for example, media players, notebook computers, cellular phones, personal data assistants, voice recorders), multiprocessor systems, microprocessor-based systems, set top boxes, game consoles, programmable consumer electronics, network PCs, minicomputers, mainframe computers, distributed computing environments that include any of the above systems or devices, and the like.

FIG. 2 illustrates an example of a suitable computer. This is only one example of a suitable computer and is not intended to suggest any limitation as to the scope of use or functionality of such a computer.

With reference to FIG. 2, an example computer 200, in a basic configuration, includes at least one processing unit 202 and memory 204. The computer may include multiple processing units and/or additional co-processing units such as graphics processing unit 220. Depending on the exact configuration and type of computer, memory 204 may be volatile (such as RAM), non-volatile (such as ROM, flash memory, etc.) or some combination of the two. This configuration is illustrated in FIG. 2 by dashed line 206.

Additionally, computer 200 may also have additional features/functionality. For example, computer 200 may also include additional storage (removable and/or non-removable) including, but not limited to, magnetic or optical disks or tape. Such additional storage is illustrated in FIG. 2 by removable storage 208 and non-removable storage 210. Computer storage media includes volatile and nonvolatile, removable and non-removable media implemented in any method or technology for storage of information such as computer program instructions, data structures, program modules or other data. Memory 204, removable storage 208 and non-removable storage 210 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computer 200. Any such computer storage media may be part of computer 200.

Computer 200 may also contain communications connection(s) 212 that allow the device to communicate with other devices over a communication medium. Communication media typically carry computer program instructions, data structures, program modules or other data in a modulated data signal such as a carrier wave or other transport mechanism and include any information delivery media. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media. Communications connections 512 are devices that interface with the communication media to transmit data over and receive data from communication media, such as a network interface.

Computer 200 may have various input device(s) 214 such as a keyboard, mouse, pen, camera, touch input device, and so on. Output device(s) 216 such as a display, speakers, a printer, and so on may also be included. All of these devices are well known in the art and need not be discussed at length here. Various input and output devices can implement a natural user interface (NUI), which is any interface technology that enables a user to interact with a device in a “natural” manner, free from artificial constraints imposed by input devices such as mice, keyboards, remote controls, and the like.

Examples of NUI methods include those relying on speech recognition, touch and stylus recognition, gesture recognition both on screen and adjacent to the screen, air gestures, head and eye tracking, voice and speech, vision, touch, gestures, and machine intelligence, and may include the use of touch sensitive displays, voice and speech recognition, intention and goal understanding, motion gesture detection using depth cameras (such as stereoscopic camera systems, infrared camera systems, and other camera systems and combinations of these), motion gesture detection using accelerometers or gyroscopes, facial recognition, three dimensional displays, head, eye, and gaze tracking, immersive augmented reality and virtual reality systems, all of which provide a more natural interface, as well as technologies for sensing brain activity using electric field sensing electrodes (EEG and related methods).

A computer system that enforces licensing restrictions of computer programs on computers generally is implemented by software, such as one or more computer programs, which include computer-executable instructions and/or computer-interpreted instructions, such as program modules, being processed by a computer. Generally, program modules include routines, programs, objects, components, data structures, and so on, that, when processed by a processing unit, instruct the processing unit to perform particular tasks or implement particular abstract data types. This computer system that enforces licensing restrictions may be practiced in distributed computing environments where tasks are performed by remote processing devices that are linked through a communications network. In a distributed computing environment, program modules may be located in both local and remote computer storage media including memory storage devices.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

FIG. 3 is a data flow diagram illustrating an example implementation of a publisher's licensing system 300 for upgrading a computer program. The publisher distributes upgrades to the computer program through any of a variety of distribution channels and mechanisms.

The licensing system 300 of a publisher receives a hardware identifier 308 and a key 302 for an original computer program, and in turn provides a digitally signed license 304 for executing the computer program. For an upgrade, the publisher receives the key 302. Optionally the hardware identifier 308 and the original license 304 can be provided. In turn, the publisher provides a digitally signed token 306. The license state resulting from using the token 306 with the upgrade may be different from or the same as the license state resulting from using the license 304 with the original program. The various information about the licensing transactions, including hardware identifiers, keys, licenses, tokens, license states, and other relevant information, can be stored in a database 310.

FIG. 4 is a data flow diagram illustrating an example implementation of a computer that authenticates and authorizes execution of an upgraded computer program. In general, an upgraded application 400 has a verification module 402. Alternatively, the verification module may reside in an operating system. The verification module 402 receives token 408 associated with the upgrade. The verification module also can receive the key 410, a hardware identifier 404 from storage of the computer on which the upgrade is being executed, and the original license 406. Because the token 408 for the upgrade is digitally signed by the publisher of the upgrade, the verification module 402 can authenticate the token. If the token 408, original license 406 and key 510 are authenticated, then the system allows the upgraded program to be run, i.e., execution of the upgraded computer program is authorized.

In some cases, the original computer program and the upgraded computer program both include a verification module. Upon execution of the upgrade, both of the verification modules are executed to authenticate and authorized execution. In another implementation, the operating system provides a shared service for verification that all applications can use.

In the example where the upgrade and the original application are from two different publishers, in one implementation, the upgrade first verifies the license of the original application and then verifies the token. In another implementation, the upgrade can request the original application to verify the original license, and then the upgrade can verify its token. In another implementation, the operating system can maintain a service that verifies both the license of the original application and the token for the upgrade.

FIG. 5 is a flow chart describing an example implementation of upgrading a computer program. There are a variety of ways in which an upgrade can be received and stored on the computer, and the invention is not limited to any particular way. For example, the upgrade may be downloaded from another computer, or installed from a memory device or a storage medium. Whether the license to upgrade was purchased or free also is insignificant.

The upgrade is received 500 on the computer. Information about the proof of purchase (key) of the original program, and proof of purchase of the upgrade, are then sent 502 to a publisher's licensing system. There are a variety of ways in which this information can be transmitted to the licensing system, and the invention is not limited thereby. For example, such information can be sent by electronic mail, through a web session or other session over a computer network, and the like. The licensing system then generates and sends back 504 a token authorizing use of the upgrade with the identified original program and its key. The token is digitally signed to permit the upgrade to authenticate it. The computer then receives and stores 506 the token for future use.

FIG. 6 a flow chart describing an example implementation of authenticating and authorizing execution of an upgraded computer program.

After the computer program is upgraded, at some point a user instructs the computer to begin running the upgraded computer program. The computer executes 600 the upgraded computer program, which causes a license verification module to be activated 602. The license verification module accesses the original license for the original program, the token for the upgrade, and the original key which is associated with both the original license and the upgrade token. Next, the verification module authenticates 604 the token, the original license and the key. If the token, original license, and key are authenticated, the execution of the upgraded computer program is authorized 606, and execution commences.

With such a licensing system for use with upgrades, the upgrade process can be simplified for the user, and key management problems can be reduced. Additionally, a publisher can provide different pricing for license updates and upgrades based on the installation and use of prior versions of a computer program, or other computer programs. It is also possible for the upgrade for a computer program from a first publisher to be provided by a second publisher or author that is different from the first publisher or author. The term author or publisher is intended to mean the entity that created the computer program as a work of authorship and owns the copyrights in or rights to license that work. In such a case, license verification process of the first computer program from the first publisher accesses chain of trust information during authentication of the token to verify that the second publisher is a trusted entity. Further, the “upgrade” for a first computer program, such as an operating system, can be a second computer program which is entirely different from the first computer program, such as an application that runs on the operating system.

Any or all of the aforementioned alternate embodiments described herein may be used in any combination desired to form additional hybrid embodiments. It should be understood that the subject matter defined in the appended claims is not necessarily limited to the specific implementations described above. The specific implementations described above are disclosed as examples only.

What is claimed is:

1. A computer-implemented process comprising:
receiving a key for a first computer program from a computer into memory;
verifying the key is valid with a processor;
generating a token for a second computer program related to the first computer program for the computer with a processor;
transmitting the token to the computer for use with the second computer program based on the key from the first computer program.

2. The computer-implemented process of claim 1, wherein the second computer program is an upgrade of a first computer program.

3. The computer-implemented process of claim 1, wherein the second computer program is an update to the first computer program.

4. The computer-implemented process of claim 2, wherein the first and second computer programs are an operating system.

5. The computer-implemented process of claim 1, wherein the first computer program and the second computer program are different computer programs.

6. The computer-implemented process of claim 5, wherein the first computer program is an operating system and a second computer program is an application designed to run on the operating system.

7. The computer-implemented process of claim 5, wherein the first computer program is a first application from a first author and the second computer program is a second application from a second author different from the first author.

8. The computer-implemented process of claim 1, wherein the token has a digital signature associated with a publisher of the second computer program.

9. A computer-implemented process comprising:
receiving a request to execute a computer program on a computer, the computer program comprising a first computer program having a key and an original license, and an upgrade having a token;
authenticating the key, the original license and the token; and
authorizing execution of the computer program with the upgrade according to a license state associated with the token.

10. The computer-implemented process of claim 9, wherein the second computer program is an upgrade of a first computer program.

11. The computer-implemented process of claim 9, wherein the second computer program is an update to the first computer program.

12. The computer-implemented process of claim 10, wherein the first and second computer programs are an operating system.

13. The computer-implemented process of claim 9, wherein the first computer program and the second computer program are different computer programs.

14. The computer-implemented process of claim 13, wherein the first computer program is an operating system and a second computer program is an application designed to run on the operating system.

15. The computer-implemented process of claim 13, wherein the first computer program is a first application from a first author and the second computer program is a second application from a second author different from the first author.

16. The computer-implemented process of claim 9, wherein authenticating the token comprises verifying a digital signature associated with the token.

17. An article of manufacture comprising:
a computer storage medium;
computer program instructions stored on the computer storage medium which, when processed by a processing device, instruct the processing device to perform a process comprising:
receiving a key for a first computer program from a computer into memory;
verifying the key is valid with a processor;
generating a token for a second computer program related to the first computer program for the computer with a processor; and
transmitting the token to the computer for use with the second computer program based on the key for the first computer program.

18. The computer-implemented process of claim 2, wherein the first and second computer programs are an operating system.

19. The computer-implemented process of claim 1, wherein the first computer program and the second computer program are different computer programs.

20. The computer-implemented process of claim 5, wherein the first computer program is an operating system and a second computer program is an application designed to run on the operating system.
